(19) United States
(12) Patent Application Publication
(10) Pub. No.: US 2026/0269865 A1
(43) Pub. Date: Sep. 10, 2026

(54) WIRELESS POWER TRANSMITTER

(71) Applicants: STMicroelectronics (Grenoble 2) SAS, Grenoble (FR); STMicroelectronics Austria GmbH, Graz (AT)

(72) Inventors: Martin Rampetsreiter, Graz (AT); Bruno Tisserand, Grenoble (FR); Rene Wutte, Sankt Bartholomä (AT); Martin Denda, Graz (AT)

(21) Appl. No.: 19/130,811

(22) PCT Filed: Nov. 30, 2022
(86) PCT No.: PCT/FR2022/052202

§ 371 Date: May 29, 2026

(51) Int. Cl. H04B 5/79; H02J 50/10; H02J 50/80

(52) U.S. Cl. CPC H04B 5/79; H02J 50/10; H02J 50/80

(57) ABSTRACT

According to an embodiment, a wireless power transmission system includes a wireless power transmitter with a power transmitter circuit and a first Near Field Communication (NFC) device. The first NFC device includes a first NFC antenna and a wake-up circuit that periodically transmits an NFC signal during a standby mode, monitors an impedance characteristic of the first NFC antenna, detects changes in the impedance characteristic, and transitions to an active communication mode when a change is detected. In the active mode, the first NFC device establishes bidirectional NFC communications with a second NFC device of a kitchen appliance through a polling procedure. The system enables efficient power transfer initiation while maintaining low standby power consumption, as the transmitter remains in standby mode until the kitchen appliance is detected through impedance changes, eliminating the need for continuous active scanning.

### TECHNICAL FIELD

The present disclosure relates generally to the field of wireless power transmission, and in particular to wireless power transmission between a power transmitter, such as a kitchen hob, and a power receiver, such as a kitchen appliance, for example according to the Ki Cordless Kitchen standard.

### BACKGROUND

Wireless power transfer (WPT) or wireless power transmission, is used for various applications. One technique of wireless power transmission uses inductive coupling between a power transmitter and a power receiver, for example a resonant inductive coupling. For example, a power transmitter, connected to a power source, converts electrical current into an alternating electromagnetic field through a first induction coil, and sends it to a power receiver. The power receiver comprises a second induction coil electromagnetically coupled to the first induction coil, and the electromagnetic field formed by the first induction coil induces an alternating current (AC) in the second induction coil. The induced alternating current may directly drive (supply) a load, or may drive a load with a direct current (DC) voltage generated by a rectifier in the power receiver. According to a resonant inductive coupling technique, each of the power transmitter and the power receiver comprises a resonant circuit (or oscillating circuit, or resonant tank), which may consist of a capacitor connected to the induction coil, or a self-resonant coil, and the oscillating circuits of the power transmitter and the power receiver are tuned to resonate at the same resonant frequency.

One emerging standard is the “Ki Cordless Kitchen standard” (“Ki standard”) developed by the Wireless Power Consortium (WPC), which is dedicated to the wireless transmission of power to cordless kitchen appliances, such as rice cookers, toasters, blenders, coffee makers, kettles, fryers and more.

In some applications, a wireless communication is required between the power transmitter and the power receiver, for example to initialize the power transfer and/or to adjust the supplied power level during the power transmission.

According to the Ki standard, communication between the power transmitter, such as a kitchen hob, and the power receiver, such as a kitchen appliance, is typically based on a Near-Field Communication (NFC) technology.

Near-Field communication technology typically uses a radiofrequency electromagnetic field generated by a first NFC device to detect, and communicate with, a second NFC device within range. Depending on the application, for a communication, one of the first and second NFC devices operates in so-called reader mode, while the other of the first and second NFC devices operates in so-called card mode, or both the first and second NFC devices communicate in peer-to-peer (P2P) mode.

For example, for wireless power transmission to a kitchen appliance, the first NFC device is coupled to the wireless power transmitter, such as a kitchen hob, and the second NFC device is coupled to the kitchen appliance, acting as a wireless power receiver.

### SUMMARY

There is a need for improving wireless power transmission between a wireless power transmitter and a kitchen appliance acting as a wireless power receiver. In particular, there is a need for an improved wireless power transmitter able to consume less energy, in particular when the kitchen appliance is not in the field of the power transmitter. There is also a need for safer wireless power transmission.

One embodiment addresses all or some of the drawbacks of known wireless power transmitters.

One embodiment provides a wireless power transmitter comprising:
a power transmitter circuit adapted to be electromagnetically coupled to a power receiver circuit of a kitchen appliance, the power transmitter circuit being adapted to transfer power to the kitchen appliance, for example according to the Ki Cordless Kitchen standard;
a first NFC device comprising a first NFC antenna, the first NFC device being adapted to be electromagnetically coupled to a second NFC device of the kitchen appliance;
wherein the first NFC device is coupled to the power transmitter circuit, and comprises a wake-up circuit adapted to:
periodically transmit an NFC signal, via the first NFC antenna, during a standby mode of the first NFC device; then
detect a change of impedance of the first NFC antenna during the standby mode; and, when a change of impedance is detected,
exit the standby mode and enter a second mode in which a polling procedure is used to establish NFC communications with the second NFC device.

According to one embodiment, the wake-up circuit comprises:
a low-power generator coupled to input terminals of the first NFC antenna, for example through an oscillating circuit of the first NFC device, and adapted to generate the NFC signal; and
a detection unit coupled to output terminals of the first NFC antenna, and adapted to detect a change of impedance in response to the NFC signal.

According to one embodiment, the detection unit is coupled to the output terminals of the first NFC antenna through a capacitor divider of the wake-up circuit.

According to one embodiment, the first NFC device comprises an amplifier positioned between, and coupled to, the wake-up circuit and the first NFC antenna, for example between a low-power generator adapted to generate the NFC signal and the first NFC antenna.

According to one embodiment, the power transmitter circuit further comprises an antenna and an inverter unit adapted to change the amplitude and/or the frequency of an electrical power signal sent to the antenna, the inverter unit being coupled, for example connected, to the first NFC device.

According to a further embodiment, there is provided a method for transferring power from a wireless power transmitter to a kitchen appliance, the method comprising, using a wake-up circuit included in a first NFC device of the wireless power transmitter:
periodically transmitting an NFC signal, via a first NFC antenna included in the first NFC device, during a standby mode of the first NFC device; then
detecting a change of impedance of the first NFC antenna during the standby mode; and, when a change of impedance is detected,
exiting the standby mode, and entering a second mode in which a polling procedure is used to establish NFC communications with a second NFC device of the kitchen appliance.

According to one embodiment, the polling procedure comprises a polling sequence as defined in the specifications of the NFC Forum.

According to one embodiment, the NFC signal comprises at least one electromagnetic detection burst.

According to one embodiment, the NFC signal comprises a plurality of electromagnetic detection bursts, the detection bursts being spaced apart by a duration corresponding to at least one hundred times the duration of each detection burst.

According to one embodiment, the detection of change of impedance is based on the detection of a change of an amplitude and/or a phase of an electrical signal across terminals of the first NFC antenna, or across terminals of an oscillating circuit connected to, or including, the first NFC antenna.

According to one embodiment, the first NFC device exits the standby mode when the amplitude and/or the phase of the electrical signal crosses at least one detection threshold.

According to one embodiment, the wake-up circuit comprises an Analog-to-Digital Converter configured to convert the electrical signal amplitude into a digital value and compare the digital value with at the least one first detection threshold, using a digital comparator of the wake-up circuit.

According to one embodiment, the first NFC device enters the second mode when the electrical signal amplitude is under the at least one first detection threshold.

According to one embodiment, the wake-up circuit comprises an Analog-to-Digital Converter configured to convert the electrical signal phase into a digital value and compare the digital value with at the least one second detection threshold, using a digital comparator of the wake-up circuit.

According to one embodiment, the first NFC device enters the second mode when the digital value of the electrical signal phase is above the at least one second detection threshold.

According to a further aspect, there is provided a wireless power transmission system comprising:
a wireless power transmitter in accordance with any of the embodiments above; and
a kitchen appliance comprising a power receiver circuit adapted to be electromagnetically coupled to the power transmitter circuit of the wireless power transmitter, and a second NFC device adapted to be electromagnetically coupled to the first NFC device of the wireless power transmitter.

According to one embodiment, the second NFC device further comprises a user interface unit adapted to receive a user command, for example to start a power transfer at a desired power level, to change the power level of the power transfer, or to stop the power transfer, and to send the user command to the power transmitter through the first NFC device.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 is a timing diagram illustrating a polling mode of a Near-Field communication device;

FIG. 2 schematically illustrates, in the form of blocks, a wireless power transmission system comprising a wireless power transmitter according to an embodiment;

FIG. 3 is a graph illustrating an example of the evolution, as a function of time, of an amplitude of an electrical signal across terminals of an oscillating circuit of a first NFC device, in a wireless power transmitter according to an embodiment;

FIG. 4A schematically illustrates, in the form of blocks, an example of a wake-up circuit of a first NFC device, in a wireless power transmitter according to an embodiment;

FIG. 4B is a graph illustrating another example of the evolution, as a function of time, of an amplitude of an electrical signal across terminals of an oscillating circuit of a first NFC device, in a wireless power transmitter according to an embodiment;

FIG. 5A schematically illustrates, in the form of blocks, another example of a wake-up circuit of a first NFC device in a wireless power transmitter according to an embodiment; and

FIG. 5B is a graph illustrating another example of the evolution, as a function of time, of a phase of an electrical signal across terminals of an oscillating circuit of a first NFC device in a wireless power transmitter according to an embodiment.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, the NFC communication protocols and the usual electronic devices or circuits implementing these protocols have not been described, these protocols being well-known by one skilled in the art and being compatible with the described embodiments.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10 %, and preferably within 5 %.

In the following disclosure, when reference is made to a “power transmitter” or a “transmitter”, it designates a wireless power transmitter. Similarly, when reference is made to a “power receiver” or a “receiver”, it designates a wireless power receiver, and when reference is made to a “power transmission system”, it designates a wireless power transmission system.

In the following disclosure, when reference is made to an “NFC device”, it designates an electronic device incorporating one or several near-field communication (NFC) circuits. The near-field communication circuits each have various elements or electronic circuits for generating or detecting a radiofrequency signal using an NFC antenna, and/or modulation or demodulation circuits. Each NFC antenna may comprise, or be part of, an oscillating circuit.

For establishing a communication between two NFC devices, for example in a so-called polling mode, an electromagnetic field generated by a first NFC device is detected by a second NFC device located in its field (within range). A coupling is then formed between the circuits of the two NFC devices. In practice, for establishing a communication, a corresponding variation in phase and/or amplitude of the emitted electromagnetic field is detected in return by the first NFC device, which then initiates an NFC communication protocol with the second NFC device. Once the first NFC device has detected the presence of the second NFC device in its field, it initiates a communication establishment procedure involving transmissions of requests by the first and/or the second NFC device, and responses by the second and/or the first NFC device.

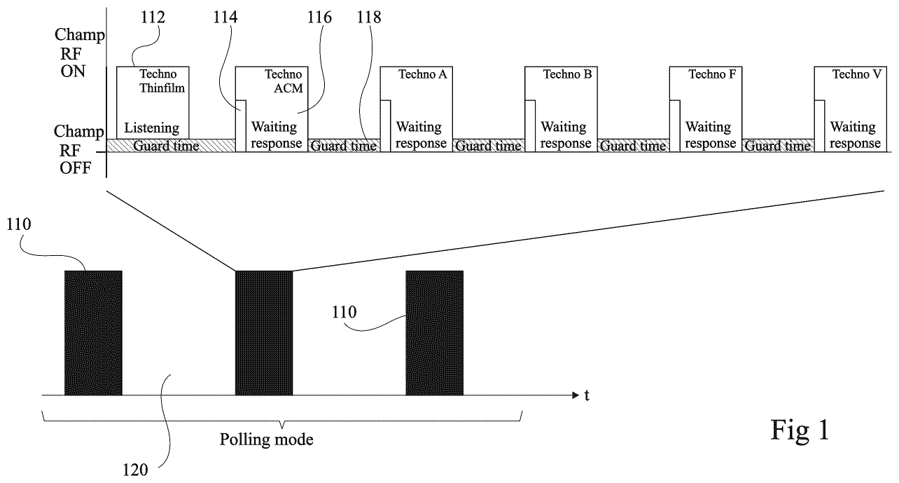

FIG. 1 is a timing diagram illustrating a polling mode of an NFC device, for example a first NFC device, polling for a second NFC device.

In the example represented in FIG. 1, the first NFC device transmits periodic polling frames 110, during which it generates an electromagnetic field to detect whether the second NFC device is within range (polling mode). The frames 110 are spaced apart by intervals 120 during which the first NFC device can detect a variation in phase and/or amplitude of the emitted electromagnetic field (listening mode) due to the presence, within range, of the second NFC device.

For example, each frame 110 begins with a listening period 112 (Techno ThinFilm, Listening) in which the first NFC device monitors its environment to determine if the second NFC device is within range.

The listening period 112 is followed by one or several bursts 114. A single frame 110 is, for example, made up of a succession of five transmission bursts 114, each configured in a different type of modulation technology. The types of technologies targeted by the bursts 114 may be successively ACM technology (Techno ACM), ISO 14443-A technology (Techno A), ISO 14443-B technology (Techno B), FeliCa 212 kbps or 424 kbps technology (Techno F) and the technology known as “Vicinity cards” or ISO 15693 (Techno V). Requests ACM, A, B, F, V are described for example in the standard polling loop of the NFC Forum standard.

In the example represented in FIG. 1, each of the transmission bursts 114 is followed by a waiting time 116 (Waiting response). During the waiting time 116, the first NFC device waits for a possible response from the second NFC device in its field.

Each of the five bursts 114 may be preceded by a Guard time 118 (Guard Time) during which the first NFC device configures the protocol of the burst 114 in the desired technology.

In order to implement a wireless power transmission between a power transmitter, such as a kitchen hob, and a kitchen appliance acting as a power receiver, according to the Ki Cordless Kitchen standard, which is based on a Near-Field communication technology, the first NFC device may be coupled to, or comprised in, the power transmitter, and the second NFC device may be coupled to, or comprised in, the kitchen appliance, acting as a power receiver. For example, to initialize the power transfer, the first NFC device performs polling for the second NFC device, such that, as soon as a kitchen appliance is within range of, for example placed on, the power transmitter, the initialization phase starts, for example to start the wireless power transfer.

However, one particularity of the cordless kitchen application is that the power transmitter can stay in a polling mode for long periods. For example, the power transmitter stays permanently in the polling mode in between operating phases when a kitchen appliance is present and the power transmitter is in use. Therefore, the polling mode during the non-use of the kitchen appliance tends to consume significant amounts of energy unnecessarily.

In the application targeted by the present description, it is expected that, when the kitchen appliance is not active, the power consumption of the NFC devices is significantly reduced. It is also expected, for safety reasons, that the power transfer does not start if the kitchen appliance is not within range, for example is not placed on, the power transmitter.

Solutions to initialize the power transfer could be based on impedance variation detection directly by the power transmitter, for example by semi-continuously measuring the impedance at the antenna of the power transmitter, which can change if a power receiver (or another object) is placed within range, or on a user command, or on a timer event. However, these solutions are generally complex, and prone to errors.

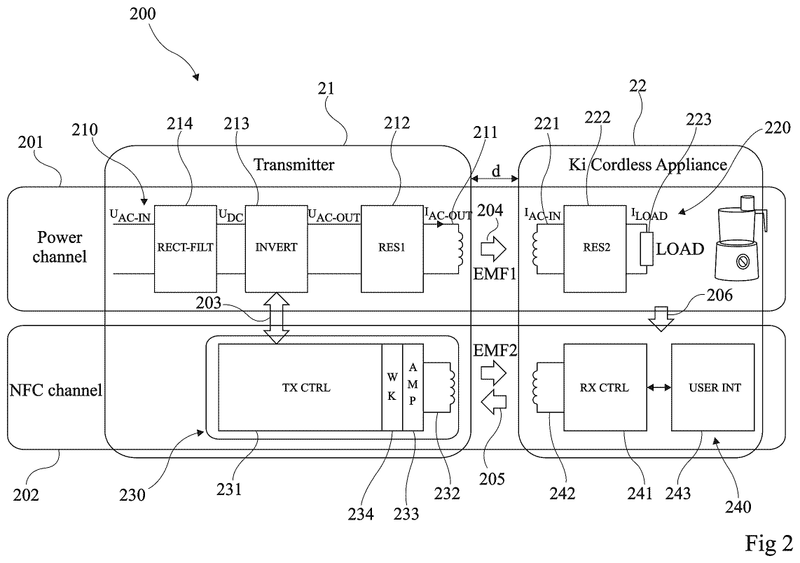

FIG. 2 schematically illustrates, in the form of blocks, a wireless power transmission system 200 comprising a wireless power transmitter 21 according to an embodiment.

The wireless power transmission system 200 is adapted to transfer power from a power transmitter 21 (Transmitter), for example a kitchen hob, to a kitchen appliance acting as a power receiver 22 (Ki Cordless appliance), using Near-Field communications for controlling the power transfer. The wireless power transmission system 200 includes a power transmission channel 201 (Power channel) and a Near-Field communication channel 202 (NFC channel).

The power transmitter 21 comprises a power transmitter circuit 210 (in the power transmission channel 201), and a first NFC device 230 (in the NFC channel 202).

The power receiver 22 comprises, or is coupled to, a power receiver circuit 220 (in the power transmission channel 201) and a second NFC device 240 (in the NFC channel 202).

The power transmitter 21 and the power receiver 22 are separated by a distance d.

The power transmitter circuit 210 comprises:
a power source (not represented) adapted to supply an input power, represented as an input AC (alternating current) voltage UAC-IN (for example 230V at 50 Hz);
a rectifier/filter unit 214 (RECT-FILT) coupled, for example connected, to the power source and adapted to convert the input AC voltage UAC-IN into a DC (direct current) voltage UDC;
an inverter unit 213 (INVERT) coupled, for example connected, to the rectifier/filter unit 214 and adapted to convert the DC voltage UDC into an output AC voltage UAC-OUT having a different amplitude and frequency from that of the input AC voltage UAC-IN (for example about 200V at about 300 kHz), and to provide the output AC voltage UAC-OUT to output terminals of the inverter unit 213; and
a first oscillating circuit 212 (RES1) coupled, for example connected, to the output terminals of the inverter unit 213, and adapted to apply the output AC voltage UAC-OUT to input terminals of a first inductive antenna 211, resulting in the generation of an alternating current IAC-OUT in the first inductive antenna 211;
the first inductive antenna 211, schematically represented as a first induction coil, coupled, for example connected, to output terminals of the first oscillating circuit 212.

The first induction coil 211 may be included in the first oscillating circuit 212.

The power receiver circuit 220 comprises:
a second inductive antenna 221, schematically represented as a second induction coil, adapted to be electromagnetically coupled to the first inductive antenna 211 in order to induce an alternating current IAC-IN in the second inductive antenna 221;
a second oscillating circuit 222 (RES2), coupled, for example connected, to the second inductive antenna 221, and adapted to transform the alternating current IAC-IN into a load current ILOAD; and
a load 223 (LOAD), coupled, for example connected, to the second oscillating circuit 222.

The second induction coil 221 may be included in the second oscillating circuit 222.

The power transmitter circuit 210 converts the input power, for example the input AC voltage UAC-IN, into an electromagnetic field 204 (EMF1) through the first induction coil 211, and sends it to the power receiver circuit 220. The electromagnetic field formed by the first induction coil 211 induces the alternating current IAC-IN in the second induction coil 221, which is directed to the second oscillating circuit 222 in order to transform the alternating current IAC-IN into a load current ILOAD. The load current ILOAD may then directly drive the load 223, or may drive the load 223 with a DC voltage generated by a rectifier in the power receiver circuit 220 (not represented).

The first NFC device 230 comprises a first control unit 231 (TX CTRL) including an amplifier 233 (AMP), and a first NFC antenna 232, schematically represented as a coil. The first NFC antenna 232 comprises two extremities, which are electrically coupled, preferably connected, to two corresponding terminals of the first control unit 231, for example, to two corresponding output terminals of the amplifier 233.

The first control unit 231 comprises:
a circuit for supplying the first NFC antenna 232 with an alternating current;
modulating and/or demodulating circuits configured to modulate and/or demodulate a radiofrequency signal in order to send data to, and/or receive data from, the second NFC device 240, using NFC communication protocols.

The first control unit 231 may be coupled to, or may include, an impedance matching circuit (not represented), which in turn is coupled to the first NFC antenna 232. The first control unit 231 may also comprise other circuits (not represented), which are usual circuits well known to a person skilled in the art.

The first control unit 231 is, for example, a microchip or electronic circuit capable of near-field communications.

The first control unit 231 may be referred as an “NFC reader”.

The amplifier 233 is adapted to amplify the alternating current, which is sent to the first NFC antenna 232. Indeed, to communicate with each other through the NFC channel 202, the power transmitter 21 and the power receiver 22 may be separated by up to a maximum distance d, preferably less than or equal to 43 mm, or substantially equal to 43 mm. The second NFC device 240 comprises a second NFC antenna 242, schematically represented as a coil and adapted to be electromagnetically coupled to the first NFC antenna 232. The distance d for example corresponds to the distance separating the first and second NFC antennas 232, 242. In order to be capable of assuring NFC communications over the distance d of up to 43 mm, the amplifier 233 is for example used to amplify the signal sent by the first NFC device 230 to the second NFC device 240.

The second NFC device 240 further comprises a second control unit 241 (RX CTRL), and a user interface 243 (USER INT).

The second NFC antenna 242 comprises two extremities, which are electrically coupled, preferably connected, to two corresponding terminals of the second control unit 241.

The second control unit 241 comprises demodulating and/or modulating circuits configured to demodulate and/or modulate a radiofrequency signal, in order to receive data from, and/or send data to, the first NFC device 230, using NFC communication protocols.

The second control unit 241 may be coupled to, or may include, an impedance matching circuit (not represented), which in turn is coupled to the second NFC antenna 242. The second control unit 241 may also comprise other circuits (not represented), which are usual circuits well known to a person skilled in the art.

The second control unit 241 is, for example, a microchip or electronic circuit capable of near-field communications.

The first control unit 231 is coupled, for example connected, to the inverter unit 213, for example in order to control the inverter unit 213 to start the power transfer, to change, in the output AC voltage UAC-OUT, the power sent to the power receiver 22, or to stop the power transfer. The inverter unit 213 may also communicate with the first control unit 231, for example in order to provide information regarding its state and/or to acknowledge control signals provided by the first control unit 231. The two-way communication is represented by a double arrow 203.

The power receiver circuit 220 is coupled, for example connected, to the second NFC device 240, for example in order to send information about the state of the load of the power receiver 22. The single-way communication is represented by a single arrow 206.

The user interface 243, for example a push-button, a switch, a keyboard, a keypad, a touch screen . . . , is adapted to receive user commands from a user, for example to start the power transfer at a desired power level, to change the power level or to stop the power transfer. The second NFC device 240 is adapted to convert a user command into a radiofrequency signal, which is sent to the first control unit 231 using the NFC channel 202. The first control unit 231 is then configured to control the inverter 213, as explained above.

Although not shown in FIG. 2, the first NFC device 230 and the second NFC device 240 generally comprise other circuits, which are usual circuits well known to a person skilled in the art.

Depending on the communication, one of the first and second NFC devices may operate in a reader mode, while the other of the first and second NFC devices operates in card mode, or both first and second NFC devices communicate in peer-to-peer (P2P) mode (represented by two arrows 205).

For example, when the first NFC device 230 seeks to detect the presence of the second NFC device 240 within range, the first NFC device 230 operates in reader mode, and the second NFC device 240 operates in card mode.

According to some embodiments, to address the problem of energy consumption and safety, for example when the kitchen appliance 22 is not active, the NFC devices, and in particular the first NFC device 230, are preferably placed in a standby mode, also referred to as a low-power mode. In the standby mode, the first NFC device 230 can perform a low-power detection method, for example a detection loop, in order to detect whether the second NFC device 240 is within range. The low-power detection method is based on an impedance change detection at the first NFC antenna 232. The low-power detection method is different from that done in the polling mode, such as the polling mode described in relation with FIG. 1, in that, in the standby mode, the transmission of the electromagnetic field is done without the polling frames. Instead, for example, the first NFC device 230 transmits periodic short detection bursts (electromagnetic detection bursts), during which it generates an electromagnetic field in order to detect whether the second NFC device 240, or another foreign object within the field of the NFC antenna 232 of the first NFC device 230, is within range. These detection bursts have a significantly shorter duration (in a ratio of at least ten, preferably at least one hundred) when compared to the duration of the polling bursts, which allows to reduce energy consumption. The low-power detection method may be based on a detection of an amplitude and/or a phase change of an electrical signal across terminals of the first NFC antenna, for example across terminals of an oscillating circuit comprising the first NFC antenna, as described hereafter.

Preferably, a state machine is used for the emission of detection bursts in the standby mode. This avoids waking up a microcontroller of first NFC device 230 and thus enables said first NFC device to remain in the standby mode during these emissions.

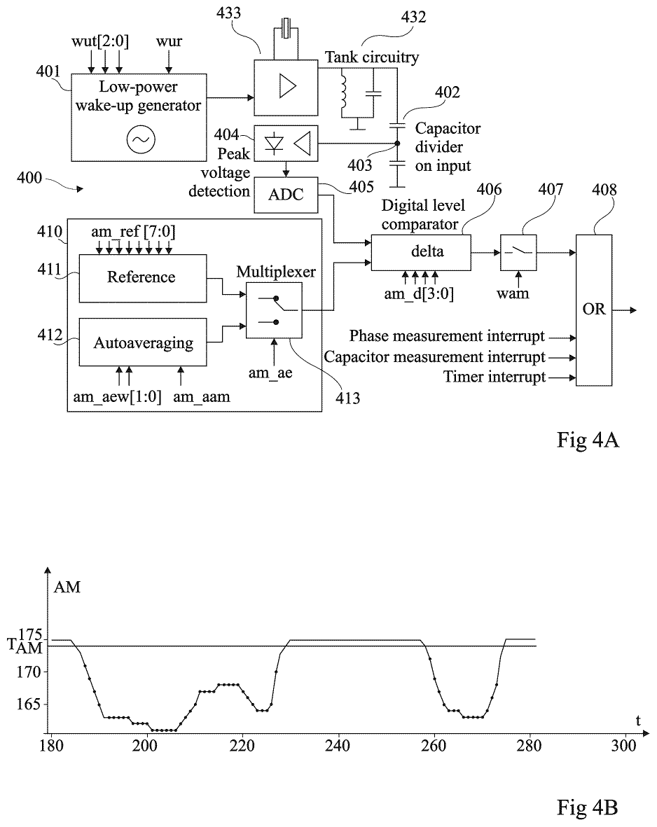

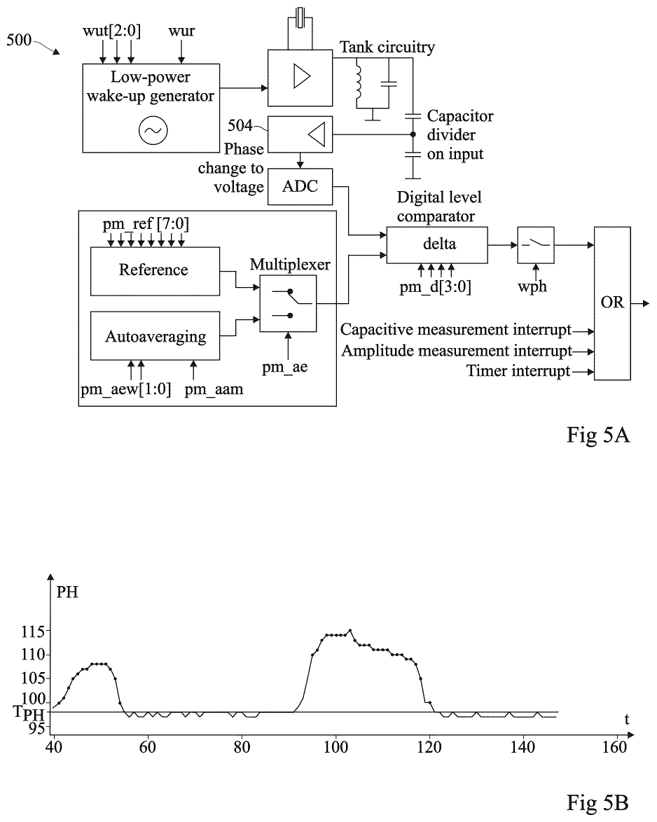

The first control unit 231 comprises a wake-up circuit 234 (WK) configured to perform the low-power detection method in the standby mode, in order to detect whether the second NFC device 240, or another object, is within range, and to exit standby mode to a second mode for communication purposes. For example, the second mode comprises a polling mode. Two examples of wake-up circuits are described hereafter, one based on an amplitude change (FIG. 4A) and another based on a phase change (FIG. 5A).

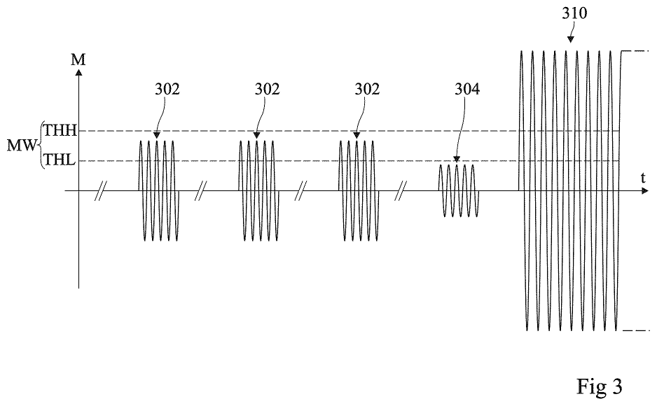

FIG. 3 is a graph illustrating an example of the evolution, as a function of time t (on the x-axis), of an amplitude M (on the y-axis, arbitrary units) of an electrical signal across terminals of an oscillating circuit of a first NFC device 230 in a wireless power transmitter according to an embodiment.

FIG. 3 illustrates an amplitude change, but the principle would be similar for a phase change.

When it is in standby mode, the first NFC device 230, seeking to detect the presence of the second NFC device 240 within range, periodically emits a detection burst 302 during which it generates an electromagnetic field EMF2 (electromagnetic detection burst). This detection burst 302 generally only includes a carrier, typically at 13.56 MHz, without modulation, and has a relatively short duration relative to an interval between two detection bursts, the detection burst 302 preferably having duration of at least one hundred times less than the duration of the interval between detection bursts. The interval between two detection bursts depends on the NFC devices, but is generally several hundred milliseconds (typically 256 ms), while the duration of each detection burst 302 is in the order of about ten or one hundred microseconds, for example between ten and one hundred microseconds.

When the second NFC device 240 is located within range, a coupling is formed between the first NFC device 230 and the second NFC device 240. This coupling modifies the load on the oscillating circuit of the first NFC device 230, which results in a variation of a characteristic property of an electrical signal across the terminals of this oscillating circuit, during a corresponding return burst 304. In practice, the modification of the load on the oscillating circuit of the first NFC device 230 results in an amplitude variation (as in the represented example), and a phase variation, of the electrical signal across the terminals of the oscillating circuit during the return burst 304. The amplitude and phase variation may be detected by variations of signals supplied by a baseband detector measuring the signal across the oscillating circuit.

In the example of FIG. 3, it is arbitrarily presumed that the presence of the second NFC device 240 causes a drop-in amplitude. However, the presence of the second NFC device 240 can, depending on the case, alternatively cause an increase in amplitude. Regarding a phase change, the presence of the second NFC device 240 may cause a positive or negative phase shift.

In the illustrated example, if the variation in amplitude M is sufficient to depart from a window or range MW of amplitudes, delimited by a lower detection threshold THL (or low threshold) and by an upper detection threshold THH (or high threshold), the first NFC device 230 switches to the second mode, that is to say it leaves the standby mode, and then emits normally, for example starts with a polling mode, with polling frames 310. Similarly, if the phase variation (not shown) is sufficient to depart from a window or range of phases delimited by lower and upper thresholds, the first NFC device 230 switches to the second mode, that is to say it leaves the standby mode, and then emits normally, for example starts with a polling mode.

In other examples, such as in the examples illustrated in FIGS. 4B and 5B described after, only one detection threshold is used.

Once the first NFC device 230 has confirmed the presence of the second NFC device 240 in its field, for example using the polling frames 310, it can start a procedure for establishing communication, implementing transmissions of requests by the first NFC device 230 and responses by the second NFC device 240, or requests by the second NFC device 240 and responses by the first NFC device 230. For example, the first control unit 231 of the first NFC device 230 controls the inverter 213 of the transmitter circuit 210 to start the power transfer at a certain power level, or change the power level to be sent to the power receiver 22, or even stop the power transfer.

When the power transfer is completed or when the second NFC device 240 leaves the field, or when a user command is used to stop the power transfer, the first NFC device 230 returns to standby mode, for example after a certain length of time (in the order of a second), in order to reduce its consumption. It then again begins to emit periodic detection bursts 302 with no communication request.

FIG. 4A schematically illustrates, in the form of blocks, an example of a wake-up circuit 400 of a first NFC device in a wireless power transmitter according to an embodiment, for example the first NFC device 230 of FIG. 2, the wake-up circuit 400 being configured to supply a wake-up signal (NFC signal) to the amplifier 433 and oscillating circuit 432 of the first NFC device. The example of FIG. 4A is based on amplitude measurement (wam).

The wake-up circuit 400 comprises a low-power generator 401 (Low-power wake-up generator) coupled to the oscillating circuit (Tank circuitry) 432 through the amplifier 433. For example, the oscillating circuit 432 includes, or corresponds to, the first NFC antenna 232 of the first NFC device 230. For example, the amplifier 433 is similar to the amplifier 233 of FIG. 2, except that the amplifier 433 is integrated in an integrated circuit (IC) implementing all or part of the wake-up circuit 400, such as an NFC reader IC of the wake-up circuit 400, whereas the amplifier 233 is for example an external amplifier.

The low-power generator 401 is adapted to generate the wake-up signal, for example in the form of an oscillating current. For example, the low-power generator 401 is active throughout the standby mode of the first NFC device 230. For example, the low-power generator 401 continuously generates, during the standby mode, a current of about 3 μA, and periodically generates current pulses, for example of about 150 to 200 mA. Input signals (wur, wut) configure the intervals at which the low-power generator generates the current peaks. For example, the input signal wut is a 3-bit signal wut[2:0] indicating the wake-up timer timeout value, and the signal wur is a 1-bit signal indicating the wake-up timer range.

The generated current induces an electromagnetic field in the first NFC antenna 232. If the second NFC device is located within range, the load on the oscillating circuit 432 of the first NFC device 230 changes, which results in a variation of the amplitude of the voltage across the terminals of the oscillating circuit 432.

The terminals of the oscillating circuit 432 are coupled, for example connected, to an input of a capacitive voltage divider 402 (Capacitor divider on input), comprising first and second capacitors coupled in series between the oscillating circuit 432 and ground. An output node 403 of the capacitive voltage divider 402, between the first and second capacitors, is coupled, for example connected, to a peak voltage detection unit 404 (Peak voltage detection) adapted to measure the voltage amplitude. The peak voltage detection unit 404 is coupled, for example connected, to an Analog-to-Digital Converter 405 (ADC), in order to convert the measured voltage amplitude into a digital value.

The wake-up circuit 400 also comprises a reference supply circuit 410, adapted to supply reference values (thresholds) to which the digital value can be compared.

For example, the reference supply circuit 410 comprises a reference register 411 (Reference), configured to store reference values (input signal am_ref). For example, the input signal am_ref is an 8-bit signal am_ref[7:0] indicating the amplitude measurement reference register to be used.

The reference supply circuit 410 may also comprise an auto-averaging unit 412 (Autoaveraging) adapted to dynamically adapt reference values on varying environment conditions, for example using a weighted moving average. For example, in the auto-averaging unit 412, each time a new digital value is measured, the weighted difference between the new value (input signal am_aew) and a stored value is added to the stored value, given that some measured values may be excluded of the averaging (input signal am_aam). For example, the input signal am_aew is a 2-bit signal am_aew[1:0] indicating the weight of last measurement result for auto-averaging, and the signal am_aam is a 1-bit signal indicating whether or not a measurement exceeding the reference is to be included in the auto-averaging.

The reference supply circuit 410 may further comprise a multiplexer 413 (Multiplexer), controlled to select between the reference register 411 and the auto-averaging unit 412. The multiplexer 413 is, for example controlled by a control signal am_ae.

The wake-up circuit 400 further comprises a digital comparator unit 406 (Digital level comparator, delta) adapted to compare the digital value of the voltage amplitude with the reference value(s) (input signal am_d). For example, the input signal am_d is a 4-bit signal am_d[3:0] defining a difference ? am between the reference and the measurement that is exceeded in order for the digital comparator unit 406 to generate an interrupt. In some cases, this difference ? am is equal to zero.

If the digital value of the measured voltage amplitude is outside the limit defined by the reference value(s), the wake-up circuit 400 triggers an interrupt. This causes the first NFC device to wake-up and, for example, to start a polling mode. In some embodiments, the interrupt is supplied via a switch 407 controlled by a control signal wam. For example, the input signal wam is a 1-bit signal indicating the generating of an interrupt if the amplitude difference is larger than? am.

The wake-up circuit 400 may also comprise an OR logic gate 408 (OR) coupled, preferably connected, to the output of the comparator 406, for example via the switch 407. The OR logic gate 408 is adapted to receive other interrupt signals, such a phase measurement interrupt signal (Phase measurement interrupt), a capacitive measurement interrupt signal (Capacitor measurement interrupt), and/or a timer interrupt signal (Timer interrupt). For example, if at least one interrupt is triggered, then the first NFC device is configured to wake up. The OR logic gate 408 may be coupled to other wake-up circuits, or other circuits adapted to output interrupt signals.

FIG. 4B is a graph illustrating another example of the evolution, as a function of time t (on the x-axis) of an amplitude AM (on the y-axis, arbitrary units) of an electrical signal across the terminals of an oscillating circuit of a first NFC device.

In the illustrated example, if the amplitude AM falls below a threshold TAM, the first NFC device switches to the second mode, that is to say, it leaves the standby mode.

FIG. 5A schematically illustrates, in the form of blocks, another example of a wake-up circuit 500 of a first NFC device in a wireless power transmitter according to an embodiment.

The wake-up circuit 500 is similar to the wake-up circuit 400 of FIG. 4A, except that the measurement value is taken from the phase measurement (wph), instead of an amplitude measurement wam, and the peak voltage detection unit 404 of FIG. 4A is replaced by a phase change to voltage unit 504 (phase change to voltage). Circuits for converting a phase change into a voltage signal are known to those skilled in the art, and will not be described in detail herein.

FIG. 5B is a graph illustrating another example of the evolution, as a function of time t (on the x-axis) of a phase PH (on the y-axis, arbitrary units) of an electrical signal across the terminals of an oscillating circuit of a first NFC device.

In the illustrated example, if the phase PH comes above a threshold TPH, the first NFC device switches to the second mode, that is to say, it leaves the standby mode.

FIGS. 4A and 5A illustrate circuits adapted to compare the electrical signal across the terminals of the oscillating circuit of the first NFC device with one reference value (one threshold). Those skilled in the art will understand how to adapt the circuits of FIGS. 4A and 5A to compare the electrical signal with two (or more) thresholds, for example using at least two comparators, and two corresponding comparator circuits.

The wake-up circuit 400, 500 of FIG. 4A or 5A is included in a wireless power transmitter according to an embodiment, more precisely in the first NFC device of the wireless power transmitter, for example the first NFC device 230 of FIG. 2. For example, the wake-up circuit 400, 500 is included in the first control unit 231 of FIG. 2. For example, the wake-up circuit 234 of FIG. 2 corresponds to the wake-up circuit 400 of FIG. 4A or the wake-up circuit 500 of FIG. 5A.

When the wake-up circuit detects the second NFC device, which is coupled to, or included in, the kitchen appliance, the first NFC device switches to the second mode. If the presence of the kitchen appliance is then confirmed by the polling procedure, the information is transmitted to the power transmitter circuit, which is configured to respond by initializing the power transfer to the kitchen appliance.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1-17. (canceled)

18. A wireless power transmitter, comprising:
a power transmitter circuit configured to electromagnetically couple to a power receiver circuit of a kitchen appliance and transfer power to the kitchen appliance; and
a first Near Field Communication (NFC) device coupled to the power transmitter circuit, the first NFC device comprising:
a first NFC antenna electromagnetically couplable to a second NFC device of the kitchen appliance, and
a wake-up circuit configured to:
periodically transmit an NFC signal via the first NFC antenna during a standby mode of the first NFC device,
monitor an impedance characteristic of the first NFC antenna during the standby mode,
detect a change in the impedance characteristic of the first NFC antenna during the standby mode, and
transition from the standby mode to an active communication mode in response to detecting the change in the impedance characteristic, wherein, in the active communication mode, the first NFC device executes a polling procedure to establish bidirectional NFC communications with the second NFC device.

19. The wireless power transmitter of claim 18, wherein the wake-up circuit comprises:
a low-power generator coupled to input terminals of the first NFC antenna and configured to generate the NFC signal; and
a detection circuit coupled to output terminals of the first NFC antenna and configured to detect the change in the impedance characteristic in response to the NFC signal.

20. The wireless power transmitter of claim 19, wherein the detection circuit is coupled to the output terminals of the first NFC antenna through a capacitor divider of the wake-up circuit.

21. The wireless power transmitter of claim 18, wherein the first NFC device comprises an amplifier positioned between and coupled to the wake-up circuit and the first NFC antenna.

22. The wireless power transmitter of claim 18, wherein the power transmitter circuit further comprises:
a transmitter antenna; and
an inverter circuit coupled to the first NFC device, the inverter circuit configured to adjust at least one of an amplitude or a frequency of an electrical power signal provided to the transmitter antenna.

23. The wireless power transmitter of claim 18, wherein the polling procedure comprises a polling sequence compliant with NFC Forum specifications.

24. The wireless power transmitter of claim 18, wherein the NFC signal comprises at least one electromagnetic detection burst.

25. A method for transferring power from a wireless power transmitter to a kitchen appliance, the method comprising:
periodically transmitting, by a wake-up circuit of a first Near Field Communication (NFC) device of the wireless power transmitter, an NFC signal via a first NFC antenna during a standby mode of the first NFC device;
monitoring an impedance characteristic of the first NFC antenna during the standby mode;
detecting a change in the impedance characteristic of the first NFC antenna during the standby mode; and
transitioning, in response to detecting the change in the impedance characteristic, from the standby mode to an active communication mode in which a polling procedure establishes NFC communications with a second NFC device of the kitchen appliance.

26. The method of claim 25, wherein the NFC signal comprises a plurality of electromagnetic detection bursts, wherein the electromagnetic detection bursts are spaced apart by a duration corresponding to at least one hundred times a duration of each electromagnetic detection burst.

27. The method of claim 25, wherein detecting the change in the impedance characteristic comprises detecting at least one of a change in amplitude or a change in phase of an electrical signal across terminals of the first NFC antenna.

28. The method of claim 25, wherein transitioning from the standby mode to the active communication mode occurs in response to at least one of an amplitude or a phase of an electrical signal across the first NFC antenna crossing a detection threshold.

29. The method of claim 25, wherein the wake-up circuit comprises:
an analog-to-digital converter configured to convert an amplitude of an electrical signal across the first NFC antenna into a digital value; and
a digital comparator configured to compare the digital value with a detection threshold.

30. The method of claim 29, wherein transitioning from the standby mode to the active communication mode occurs in response to the digital value being below the detection threshold.

31. The method of claim 25, wherein the wake-up circuit comprises:
an analog-to-digital converter configured to convert a phase of an electrical signal across the first NFC antenna into a digital value; and
a digital comparator configured to compare the digital value with a phase detection threshold.

32. The method of claim 31, wherein transitioning from the standby mode to the active communication mode occurs in response to the digital value being above the phase detection threshold.

33. A wireless power transmission system, comprising:
a wireless power transmitter comprising:
a power transmitter circuit configured to electromagnetically couple to a power receiver circuit of a kitchen appliance and transfer power to the kitchen appliance,
a first Near Field Communication (NFC) device coupled to the power transmitter circuit, the first NFC device comprising:
a first NFC antenna; and
a wake-up circuit configured to:
periodically transmit an NFC signal via the first NFC antenna during a standby mode of the first NFC device,
monitor an impedance characteristic of the first NFC antenna during the standby mode,
detect a change in the impedance characteristic of the first NFC antenna during the standby mode, and
transition from the standby mode to an active communication mode in response to detecting the change in the impedance characteristic, wherein, in the active communication mode, the first NFC device executes a polling procedure to establish bidirectional NFC communications with a second NFC device; and
the kitchen appliance comprising:
the power receiver circuit configured to electromagnetically couple to the power transmitter circuit, and
the second NFC device configured to electromagnetically couple to the first NFC device.

34. The wireless power transmission system of claim 33, wherein the second NFC device further comprises a user interface configured to:
receive a user command related to power transfer; and
transmit the user command to the wireless power transmitter through NFC communications between the second NFC device and the first NFC device.

35. The wireless power transmission system of claim 33, wherein the NFC signal comprises a plurality of electromagnetic detection bursts, wherein the electromagnetic detection bursts are spaced apart by a duration corresponding to at least one hundred times a duration of each electromagnetic detection burst.

36. The wireless power transmission system of claim 33, wherein the second NFC device is configured to modify its antenna impedance in response to detecting the NFC signal from the first NFC device, thereby causing the change in the impedance characteristic detected by the wake-up circuit.

37. The wireless power transmission system of claim 33, wherein the kitchen appliance further comprises a controller coupled to the second NFC device and the power receiver circuit, the controller configured to:
receive power transfer parameters from the wireless power transmitter via the NFC communications;
control operation of the power receiver circuit based on the power transfer parameters; and
transmit operational status information to the wireless power transmitter via the NFC communications.
